(19) United States
(12) Patent Application Publication
(10) Pub. No.: US 2023/0342938 A1
(43) Pub. Date: Oct. 26, 2023

(54) Adaptive Semi-Supervised Image Segmentation Method Based on Uncertainty Knowledge Domain and System thereof

(71) Applicant: Shandong Jianzhu University, Jinan (CN)

(72) Inventors: Xiaoming Xi, Jinan (CN); Liangyun Sun, Jinan (CN); Xiushan Nie, Jinan (CN); Guang Zhang, Jinan (CN)

(21) Appl. No.: 18/122,690

(22) Filed: Mar. 16, 2023

(30) Foreign Application Priority Data
Apr. 22, 2022 (CN) 202210423986.8

(51) Int. Cl. G06T 7/11

(52) U.S. Cl. CPC G06T 7/11; G06T 2207/20084

(57) ABSTRACT

The application belongs to the technical field of image segmentation, in particular to an adaptive semi-supervised image segmentation method based on uncertainty knowledge domain and a system thereof, including the following steps: the image to be segmented is acquired; and the image to be segmented is segmented based on the acquired image to be segmented and the preset image segmentation model; wherein, the semi-supervised segmentation model is adopted for the image segmentation model, and the image sample features of the acquired image to be segmented are extracted based on the constructed uncertainty knowledge base. Based on the domain adaptation of feature migration, the extracted image sample features are migrated to the semi-supervised segmentation model, so that the image to be segmented is segmented.

### TECHNICAL FIELD

The application belongs to the technical field of image segmentation, in particular to an adaptive semi-supervised image segmentation method based on uncertainty knowledge domain and a system thereof.

### BACKGROUND ART

The statements in this part only provides background technology information related to this application and does not necessarily constitute prior art.

Image segmentation is an important research direction of computer vision, and has been widely applied in image analysis, automatic driving, disease diagnosis, etc. In recent years, deep convolutional neural networks have made significant progress in semantic segmentation. However, the success of the method based on convolutional neural networks (CNN) benefits from vast amounts of manually labeled data. Data labeling usually requires expensive time costs, so the demand for pixel level manual labeling in fully supervised semantic segmentation makes it more expensive than other visual tasks such as object detection and image classification. The semi-supervised segmentation method can use vast amounts of unlabeled data and a small amount of labeled data to learn the segmentation model, and then solve the problem of segmentation accuracy degradation caused by less labeled data.

The inventor finds that although the existing semi-supervised methods can solve the problem of less labeled data to a certain extent, it is difficult to learn the uncertainty knowledge contained in the abnormal image (the fuzzy features contained in the abnormal image due to uncertain factors such as equipment and external acquisition environment), for example, optical coherence tomography (OCT) image anomalies (e.g. noise, boundary blur) caused by equipment, external acquisition environment and other uncertain factors, affecting the accuracy of segmentation models.

### Content of Invention

In order to solve the above problems, the application provides an adaptive semi-supervised image segmentation method based on uncertainty knowledge domain and a system thereof, introduces the regularization item of uncertainty knowledge migration, migrates the uncertainty knowledge to the image segmentation model, introduces the self-training mode, increases the amount of effective labeled data, and improves the segmentation accuracy of the semi-supervised segmentation framework. Therefore, the application effectively solves the problem of low segmentation accuracy caused by less labeled data and uncertainty factors.

According to some embodiments, the first solution of the application provides an adaptive semi-supervised image segmentation method based on uncertainty knowledge domain, which is as follows:

The adaptive semi-supervised image segmentation method based on uncertainty knowledge domain includes the following steps:

the image to be segmented is acquired;

and the image to be segmented is segmented based on the acquired image to be segmented and the preset image segmentation model;

wherein, the semi-supervised segmentation model is adopted for the image segmentation model, and the image sample features of the acquired image to be segmented are extracted based on the constructed uncertainty knowledge base. Based on the domain adaptation of feature migration, the extracted image sample features are migrated to the semi-supervised segmentation model, so that the image to be segmented is segmented.

As a further technical limit, the data set is preprocessed to enhance the data, before the uncertainty knowledge base is constructed. The preprocessing includes random clipping, horizontal flipping, vertical flipping, random rotation and adding Gaussian noise.

The image size of the preprocessed data set is normalized to ensure that all image sizes in the preprocessed data set are uniform.

Further, when constructing the uncertainty knowledge base, the image containing the features of wrong divided areas is constructed through data enhancement, and the uncertainty knowledge is obtained based on the constructed image containing the features of wrong divided areas.

Further, the pre-trained U-net network is used to segment the input image to obtain the segmentation mask map of the input image. The mask map of the label image is subtracted from the segmentation mask map of the input image to obtain a mask map containing the wrong divided areas, and the wrong divided areas are extracted.

Further, the mask map containing the wrong divided area is reversed, and the reversed mask map is obtained to reconstruct the data enhancement frame mask; the reconstructed data enhancement frame mask is dot multiplied with the reverse mask to obtain a new mask; and the data enhancement frame mask is replaced with the new mask, the input image data is enhanced, the areas not wrongly divided are replaced, and then the uncertainty knowledge base is constructed.

Further, the obtained mask map containing the wrong divided area is reversed as follows: the pixel point with a pixel value of 1 in the obtained mask map containing the wrong divided area is assigned a value of 0, and the pixel point with a pixel value of 0 in the obtained mask map containing the wrong divided area is assigned a value of 1.

As a further technical limit, the adaptive dual-branch network of uncertainty knowledge domain, which comprises a first branch and a second branch, is adopted in domain adaptation based on feature migration. The first branch obtains the intermediate feature map by extracting image sample features from the uncertainty knowledge base; and the second branch is used to extract the features of the labeled input samples in the target domain, and the feature map of the labeled target domain is obtained; and the regularization item of knowledge migration is applied to the obtained intermediate feature map and the labeled target domain feature map to complete feature migration.

Further, the weighted relative entropy is used for the regularization item of knowledge migration, and the distribution distance between the intermediate feature map and the target domain feature map is shortened by reducing the value of the relative entropy.

According to some embodiments, the second solution of the application provides an adaptive semi-supervised image segmentation system based on uncertainty knowledge domain, which is as follows:

The adaptive semi-supervised image segmentation system based on uncertainty knowledge domain comprises the following:

an acquisition module for acquiring the image to be segmented;

and a segmentation module used to segment the image to be segmented based on the obtained image to be segmented and the preset image segmentation model;

wherein, the semi-supervised segmentation model is adopted for the image segmentation model, and the image sample features of the acquired image to be segmented are extracted based on the constructed uncertainty knowledge base. Based on the domain adaptation of feature migration, the extracted image sample features are migrated to the semi-supervised segmentation model, so that the image to be segmented is segmented.

Compared with the prior art, the application has the following advantages:

The application provides an adaptive semi-supervised segmentation network based on uncertainty knowledge domain, which combines domain adaptation with semi-supervised framework, and introduces uncertainty knowledge to improve the accuracy of semi-supervised segmentation network. Different from the traditional segmentation network with a single branch structure, the network proposed in the invention adopts two branches, wherein, the first branch learns the uncertainty knowledge that is difficult to obtain in the traditional segmentation model, and incorporates the learned uncertainty knowledge into the segmentation model by introducing domain consistency constraints. Compared with the traditional semi-supervised framework, the invention aims to learn the proprietary knowledge of abnormal images and migrates it to the segmentation model, so that better segmentation effects of the abnormal images can be obtained. In addition, the application integrates regularization consistency and self-training mode, which can more effectively use unlabeled data, and further improve the accuracy of semi-supervised segmentation method.

### BRIEF DESCRIPTION OF THE DRAWINGS

The drawings of the specification that form a part of the application are for further understanding of the application. The schematic embodiments and their descriptions of the application are only used to explain the application, but do not constitute any improper limitation of the application.

FIG. 1 is the flow chart of the adaptive semi-supervised image segmentation method based on uncertainty knowledge domain of embodiment 1 of the application;

FIG. 2 is the network learning flow chart of the adaptive semi-supervised image segmentation method based on uncertainty knowledge domain of embodiment 2 of the application;

FIG. 3 is the structural block diagram of the adaptive semi-supervised image segmentation system based on uncertainty knowledge domain of embodiment 2 of the application;

### DESCRIPTION OF PREFERRED EMBODIMENTS

The application is further described below with the figures and embodiments.

### Embodiment 1

The embodiment 1 of the application introduces an adaptive semi-supervised image segmentation method based on uncertainty knowledge domain.

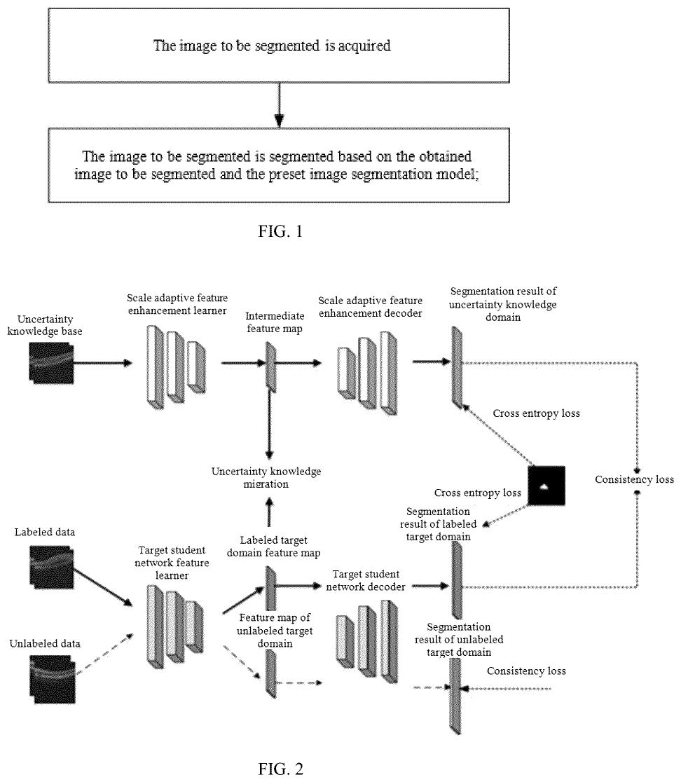

As shown in FIG. 1, the adaptive semi-supervised image segmentation method based on uncertainty knowledge domain includes the following steps:

the image to be segmented is acquired;

and the image to be segmented is segmented based on the acquired image to be segmented and the preset image segmentation model;

wherein, the semi-supervised segmentation model is adopted for the image segmentation model, and the image sample features of the acquired image to be segmented are extracted based on the constructed uncertainty knowledge base. Based on the domain adaptation of feature migration, the extracted image sample features are migrated to the semi-supervised segmentation model, so that the image to be segmented is segmented.

Specifically, as shown in FIG. 2, the adaptive semi-supervised image segmentation method based on uncertainty knowledge domain according to the embodiment includes the following steps for the network learning process of image segmentation:

Step S01: data set preprocessing;

Step S02: construction of uncertainty knowledge base;

Step S03: uncertainty knowledge transfer;

Step S04: construction of semi-supervised segmentation framework;

Step S05: network training.

As one or more embodiments, in step S01, since the image samples contained in the original data set may have inconsistent sizes, which is not conducive to feature extraction and subsequent learning of the depth network model, it is necessary to normalize the size of the existing data set, that is, scale transform all images in the data set to ensure that the sizes of all images are uniform.

To get more sample data, the data of the images in the existing data set shall be enhanced mainly by random clipping, horizontal flipping, vertical flipping, random rotation and adding Gaussian noise.

As one or more embodiments, in step S02, the method of data enhancement is used to construct the images containing the features of wrong divided areas, so that the network can learn more uncertainty knowledge through these images.

This embodiment adopts the data enhancement method of difficutycutmix, and uses U-net to pre-segment the image, find the wrong divided area in the image, and improve the replacement probability of the areas not wrongly divided (making the features of wrong divided area more prominent), so that the augmented data has the wrongly divided uncertainty areas, and then the uncertainty knowledge base is constructed. Specifically, the process of constructing the uncertainty knowledge base is as follows: the first step is to extract the wrong divided areas. First, the input image is segmented by using the pre-trained U-net network to obtain the segmentation mask map InputMask of the input image. Then, the mask map L a b e 1 Mask of the label image is subtracted with InputMask to obtain the mask map ErrorMask containing the wrong divided area:

ErrorMask=|LablelMask-InputMask| (the pixel value of the wrong divided area is 1, and the pixel value of the other areas is 0). Next, the ErrorMask is reversed to obtain a reverse mask map NErrorMask. The value of 0 is assigned to the pixel of which the pixel value is 1 in the ErrorMask, and the value of 1 is assigned to the pixel of which the pixel value is 0 in the ErrorMask to obtain NErrorMask.

The purpose of obtaining NErrorMask is to reconstruct the reconstructed data enhancement framework mask M in the CutMix framework. In order to ensure that the wrong divided area is not cut during the execution of CutMix, NErrorMask is used to reconstruct the M in the CutMix framework, so as to protect the wrong divided area during CutMix operation. M and NErrorMask are dot multiplied to get a new mask NewM, which is a new mask map code after reconstruction. After that, NewM is used to replace M in the formula of the CutMix framework, so as to enhance the data of the input image, and improve the replacement probability of the areas not wrongly divided (making the features of wrong divided area more prominent), so that the augmented data has the wrongly divided uncertainty areas, and then the uncertainty knowledge base is constructed. The formula involved in the improved CutMix is described as follows:

\tilde{x}=NewM⊙x_{A}+(1−NewM)⊙x_{B}

\tilde{y}=λy_{A}+(1−λ)y_{B}

Wherein, xA and xB are two different training samples, yA and yB are the corresponding label values. and are the new training sample and corresponding label generated. λ obeys Beta distribution: λ˜Beta (α, α)

As one or more embodiments, in step S03, the embodiment adopts an adaptive double-branch network based on uncertainty knowledge domain. The first branch is used to learn uncertainty knowledge and migrate the learned knowledge to the segmentation model (the second branch). The input of the first branch is the difficutycutmix augmented image of the input image, which uses U-net as the learning network of uncertainty knowledge. The input of the second branch is the original input image (the target in the image is consistent with the target of the augmented image), and the input image and its augmented image are distributed in two domains.

The regularization item of knowledge migration is introduced to migrate the uncertainty knowledge into the segmentation model. In this embodiment, the regularization item of knowledge migration uses the weighted relative entropy (i.e. KL divergence) to ensure that the segmentation results of the segmentation model and the uncertainty learning model are consistent.

Specifically, the scale adaptive feature enhancement learner in the first branch is used to extract the features of the samples in the uncertainty knowledge base and obtain the intermediate feature map Fuc. The target student network feature learner in the second branch is used to extract the features of the labeled input samples in the target domain and obtain the labeled target domain feature map F. The weighted KL divergence is applied to the intermediate feature map Fuc and the target domain feature map F. The value of weighted KL divergence is reduced, so as to shorten the distance between two feature distributions and realize feature migration.

Some samples in the uncertainty knowledge base need to be used as training sets to pre-train the U-net network to obtain the sample importance weight in the weighted KL divergence. The sample segmentation results in the uncertainty knowledge base can be used to calculate the sample importance weight.

The target network can learn the uncertainty knowledge contained in the samples in the uncertainty knowledge base (the features contained in the wrong divided area of samples) through feature migration. The following formula for calculating KL divergence is used as a component of the regularization item in the loss function:

$${R}_{k} = \frac{1}{{B}_{l}} {\sum }_{{x}^{i} ∈ L} {w}_{k}^{i} KL ( {Fuc}_{{θ}^{0}} ( {x}^{i} ) , {F}_{θ} ( {x}^{i} ) ) \\ {w}_{k}^{i} = G ( H ( {p}_{s}^{i} ) ) = G ( - {\sum }_{j = 1}^{{C}_{s}} {p}_{s , j}^{i} log ( {p}_{s , j}^{i} ) )$$

Wherein, G is the entropy function, H is the cross entropy loss function, p_{s,j}ⁱ is the segmentation probability graph of the network in the first branch for the uncertainty knowledge sample x^{l}, and Cₛ is the number of categories considered in the segmentation. The smaller the value of H, the larger the value of G, and the larger the value of weight wₖ^{l}.

As one or more embodiments, in step S04, the semi-supervised framework mainly includes a consistent regularization process and a self-training process, wherein, the consistent regularization uses the consistency loss of the traditional mean-teacher semi-supervised segmentation framework to train the target student network. In the process of training the target student network, the teacher network will label pseudo labels on the input unlabeled data. The target student network can be further fine tuned based on these pseudo labels, which is the self-training process in the semi-supervised framework in this embodiment.

Specifically, the mean-teacher framework uses mean square error (MSE) to calculate the consistency loss between the teacher network and the target student network, and performs exponential weighted averaging (EMA) on the parameters of the student network to obtain the parameters of the teacher network. The self-training module uses the teacher network in the mean-teacher framework to generate pseudo labels for unlabeled samples, and then uses the unlabeled samples and the pseudo labels corresponding to unlabeled samples to train the student network.

As one or more embodiments, in step S05, the network training process mainly includes the following loss functions:
(1) Cross entropy loss Lce1 and Lce2 involved in the training of labeled samples;
(2) Consistency loss Lcon1 maintaining the prediction results between the first branch and the second branch;
(3) Consistency loss Lcon2 between the teacher network and the target student network in the mean-teacher framework, and the cross entropy loss Lce3 generated in the self-training process.

The total loss function during network training can be defined as:

$$L ( θ , ϕ ; {x}^{i} \text{?} {x}_{t}^{i} , {y}_{t}^{i} , {x}^{i} \text{?} ) == Lce 1 ( {θ}^{0} , {ϕ}^{0} ; {x}^{i} \text{?} , {y}^{i} \text{?} ) + Lce 2 ( θ , ϕ ; {x}_{t}^{i} , {y}_{t}^{i} ) + Lcon 2 ( θ , ϕ , {θ}^{*} , {ϕ}^{*} ; {x}^{i} \text{?} ) + Lcon 1 ( θ , ϕ , {θ}^{0} , {ϕ}^{0} ; {x}^{i} \text{?} , {x}^{i} \text{?} ) + Lce 3 ( θ , ϕ ; {x}^{i} \text{?} , {p}^{i} \text{?} ) + R \text{?}$$

$$Lce 1 ( {θ}^{0} , {ϕ}^{0} ; {x}^{i} \text{?} , {y}_{t}^{i} ) = {L}_{CE} ( {θ}^{0} , {ϕ}^{0} ; {x}^{i} \text{?} , {y}_{t}^{i} ) \\ Lce 2 ( θ , ϕ ; {x}_{t}^{i} , {y}_{t}^{i} ) = {L}_{CE} ( θ , ϕ ; {x}_{t}^{i} , {y}_{t}^{i} ) \\ Lce 3 ( θ , ϕ ; {x}^{i} \text{?} , {p}^{i} \text{?} ) = {L}_{CE} ( θ , ϕ ; {x}^{i} \text{?} , {p}^{i} \text{?} ) \\ Lcon 1 ( θ , ϕ , {θ}^{0} , {ϕ}^{0} ; {x}_{u}^{i} ) = MSE ( {P}_{t} ( θ , ϕ ; {x}_{u}^{i} ) , P \text{?} ( {θ}^{0} , {ϕ}^{0} ; {x}_{u}^{i} ) ) \\ Lcon 2 ( θ , ϕ , {θ}^{*} , {ϕ}^{*} ; {x}_{u}^{i} ) = MSE ( {P}_{t} ( θ , ϕ ; {x}_{u}^{i} ) , P \text{?} ( θ , ϕ ; {x}_{u}^{i} ) )$$

$$\text{?} \text{indicates text missing or illegible when filed}$$

Wherein, xs is the sample in the uncertainty knowledge base, xt is the labeled sample in the original input image, xu is the unlabeled sample in the original input image, yt is the corresponding label of xt, Pre is the corresponding pseudo label of xu, Pt is the prediction result of the uncertainty knowledge segmentation network in the first branch, Ps is the prediction result of the target student network, and PTea is the prediction result of the teacher network. LCE is the cross entropy loss, and MSE is the mean square error.

MSE calculates the Euclidean distance between the predicted data and the real data. The closer the predicted value is to the real value, the smaller the mean square deviation of both. The category corresponding to the maximum score is the forecast category. The mean square error loss of the current output forecast results and the historical weighted output forecast results is calculated according to

$$MSE ( y , {y}^{*} ) = \frac{{\sum }_{i = 1}^{n} {( y - {y}^{*} )}^{2}}{n} .$$

The network repeats the reverse propagation training based on the loss function L in the learning process. The loss value slowly decreases with the increase of training rounds. The network model obtained when the loss value reaches the minimum value is the best training result.

In this embodiment, the method of difficutycutmix is used to construct an uncertainty knowledge base, which is the basis for the network learning of uncertainty knowledge. The regularization item of uncertainty knowledge migration is introduced to migrate the uncertainty knowledge to the segmentation model. On the basis of the mean-teacher framework, the self-training mode is introduced to increase the amount of effective labeled data. Finally, the segmentation accuracy of the semi-supervised segmentation framework is improved.

### Embodiment 2

The embodiment 2 of the application introduces an adaptive semi-supervised image segmentation system based on uncertainty knowledge domain.

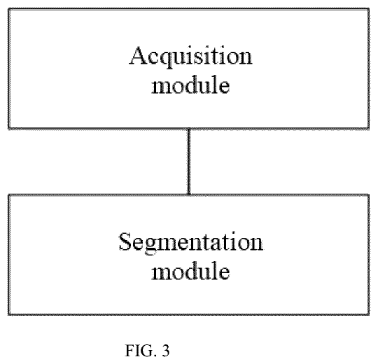

As shown in FIG. 3, the adaptive semi-supervised image segmentation system based on uncertainty knowledge domain comprises the following:

an acquisition module for acquiring the image to be segmented; and

a segmentation module used to segment the image to be segmented based on the obtained image to be segmented and the preset image segmentation model;

wherein, the semi-supervised segmentation model is adopted for the image segmentation model, and the image sample features of the acquired image to be segmented are extracted based on the constructed uncertainty knowledge base. Based on the domain adaptation of feature migration, the extracted image sample features are migrated to the semi-supervised segmentation model, so that the image to be segmented is segmented.

The detailed steps of embodiment 2 are the same as the adaptive semi-supervised image segmentation system based on uncertainty knowledge domain provided by embodiment 1, which are not repeated here.

What is claimed is:

1. An adaptive semi-supervised image segmentation method based on uncertainty knowledge domain, which is characterized by including the following steps:
the image to be segmented is acquired;
and the image to be segmented is segmented based on the acquired image to be segmented and the preset image segmentation model;
wherein, the semi-supervised segmentation model is adopted for the image segmentation model, and the image sample features of the acquired image to be segmented are extracted based on the constructed uncertainty knowledge base, Based on the domain adaptation of feature migration, the extracted image sample features are migrated to the semi-supervised segmentation model, so that the image to be segmented is segmented;
The adaptive dual-branch network of uncertainty knowledge domain is adopted in domain adaptation based on feature migration, The first branch obtains the intermediate feature map by extracting image sample features from the uncertainty knowledge base; and the second branch is used to extract the features of the labeled input samples in the target domain, and the feature map of the labeled target domain is obtained; and the regularization item of knowledge migration is applied to the obtained intermediate feature map and the labeled target domain feature map to complete feature migration.

2. The adaptive semi-supervised image segmentation method based on uncertainty knowledge domain according to claim 1 is characterized in that the data set is preprocessed to enhance the data, before the uncertainty knowledge base is constructed; The preprocessing includes random clipping, horizontal flipping, vertical flipping, random rotation and adding Gaussian noise.

3. The adaptive semi-supervised image segmentation method based on uncertainty knowledge domain according to claim 2 is characterized in that the image size of the preprocessed data set is normalized to ensure that all image sizes in the preprocessed data set are uniform.

4. The adaptive semi-supervised image segmentation method based on uncertainty knowledge domain according to claim 3 is characterized in that when constructing the uncertainty knowledge base, the image containing the features of wrong divided areas is constructed through data enhancement, and the uncertainty knowledge is obtained based on the constructed image containing the features of wrong divided areas.

5. The adaptive semi-supervised image segmentation method based on uncertainty knowledge domain according to claim 4 is characterized in that the pre-trained U-net network is used to segment the input image to obtain the segmentation mask map of the input image; The mask map of the label image is subtracted from the segmentation mask map of the input image to obtain a mask map containing the wrong divided areas, and the wrong divided areas are extracted.

6. The adaptive semi-supervised image segmentation method based on uncertainty knowledge domain according to claim 5 is characterized in that the mask map containing the wrong divided area is reversed, and the reversed mask map is obtained to reconstruct the data enhancement frame mask; the reconstructed data enhancement frame mask is dot multiplied with the reverse mask to obtain a new mask; and the data enhancement frame mask is replaced with the new mask, the input image data is enhanced, the areas not wrongly divided are replaced, and then the uncertainty knowledge base is constructed.

7. The adaptive semi-supervised image segmentation method based on uncertainty knowledge domain according to claim 6 is characterized in that the obtained mask map containing the wrong divided area is reversed as follows: the pixel point with a pixel value of 1 in the obtained mask map containing the wrong divided area is assigned a value of 0, and the pixel point with a pixel value of 0 in the obtained mask map containing the wrong divided area is assigned a value of 1.

8. The adaptive semi-supervised image segmentation method based on uncertainty knowledge domain according to claim 1 is characterized in that the weighted relative entropy is used for the regularization item of knowledge migration, and the distribution distance between the intermediate feature map and the target domain feature map is shortened by reducing the value of the relative entropy.

9. An adaptive semi-supervised image segmentation system based on uncertainty knowledge domain comprises the following:
an acquisition module for acquiring the image to be segmented;
and a segmentation module used to segment the image to be segmented based on the obtained image to be segmented and the preset image segmentation model;
wherein, the semi-supervised segmentation model is adopted for the image segmentation model, and the image sample features of the acquired image to be segmented are extracted based on the constructed uncertainty knowledge base. Based on the domain adaptation of feature migration, the extracted image sample features are migrated to the semi-supervised segmentation model, so that the image to be segmented is segmented;
The adaptive dual-branch network of uncertainty knowledge domain is adopted in domain adaptation based on feature migration. The first branch obtains the intermediate feature map by extracting image sample features from the uncertainty knowledge base; and the second branch is used to extract the features of the labeled input samples in the target domain, and the feature map of the labeled target domain is obtained; and the regularization item of knowledge migration is applied to the obtained intermediate feature map and the labeled target domain feature map to complete feature migration.
